(19) United States
(12) Patent Application Publication
(10) Pub. No.: US 2025/0232482 A1
(43) Pub. Date: Jul. 17, 2025

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Wenyi WANG, Beijing (CN); Yingzhan XU, Beijing (CN); Kai ZHANG, Los Angeles, CA (US); Li ZHANG, Los Angeles, CA (US)

(21) Appl. No.: 19/170,944

(22) Filed: Apr. 4, 2025

Related U.S. Application Data
(63) Continuation of application No. PCT/CN2023/122703, filed on Sep. 28, 2023.

(30) Foreign Application Priority Data
Oct. 4, 2022 (WO) PCT/CN2022/123706

(51) Int. Cl. G06T 9/00; G06T 9/40

(52) U.S. Cl. CPC G06T 9/001; G06T 9/40

(57) ABSTRACT

Embodiments of the present disclosure provide a method for point cloud coding. The method comprises: determining, for a conversion between a point cloud sequence comprising a current point cloud (PC) sample associated with a transform block and a bitstream of the point cloud sequence, a transform result of an attribute residual between a neighbor attribute of at least one subblock of the transform block and a predicted attribute of the at least one subblock of the transform block, the neighbor attribute being predicted based on an attribute of at least one neighbor block of the transform block; and performing the conversion at least based on the transform result of the attribute residual.

### CROSS REFERENCE TO RELATED APPLICATIONS

This application is a continuation of International Application No. PCT/CN2023/122703, filed on Sep. 28, 2023, which claims the benefit of International Application No. PCT/CN2022/123706 filed on Oct. 4, 2022. The entire contents of these applications are hereby incorporated by reference in their entireties.

### FIELDS

Embodiments of the present disclosure relates generally to point cloud coding techniques, and more particularly, to sample domain prediction for Region-Adaptive Hierarchical Transform (RAHT).

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a conversion between a point cloud sequence comprising a current point cloud (PC) sample associated with a transform block and a bitstream of the point cloud sequence, a transform result of an attribute residual between a neighbor attribute of at least one subblock of the transform block and a predicted attribute of the at least one subblock of the transform block, the neighbor attribute being predicted based on an attribute of at least one neighbor block of the transform block; and performing the conversion at least based on the transform result of the attribute residual.

In a second aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by a point cloud processing apparatus. The method comprises: determining a transform result of an attribute residual between a neighbor attribute of at least one subblock of a transform block and a predicted attribute of the at least one subblock of the transform block, the neighbor attribute being predicted based on an attribute of at least one neighbor block of the transform block; and generating the bitstream at least based on the transform result of the attribute residual.

In a fifth aspect, a method for storing a bitstream of a point cloud sequence is proposed. The method comprises: determining a transform result of an attribute residual between a neighbor attribute of at least one subblock of a transform block and a predicted attribute of the at least one subblock of the transform block, the neighbor attribute being predicted based on an attribute of at least one neighbor block of the transform block; generating the bitstream at least based on the transform result of the attribute residual; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder in accordance with some embodiments of the present disclosure;

FIG. 3 illustrates a block diagram that illustrates an example point cloud decoder in accordance with some embodiments of the present disclosure;

FIG. 4 illustrates an example diagram of parent-level nodes for each sub-node of transform unit node in accordance with some embodiments of the present disclosure;

FIG. 5 illustrates an example diagram of a coding flow for the sample domain prediction for region-adaptive hierarchical transform in accordance with some embodiments of the present disclosure;

FIG. 6 illustrates a flowchart of a method for point cloud coding in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

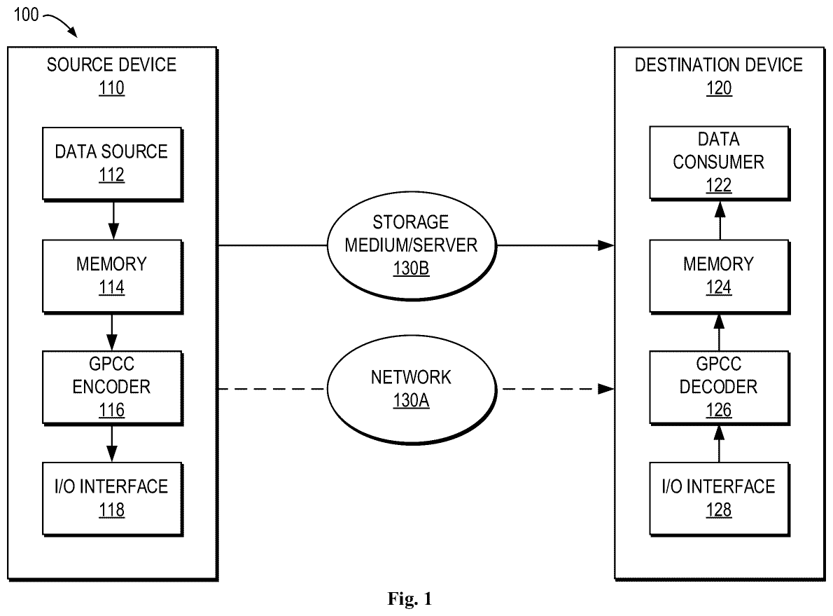

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

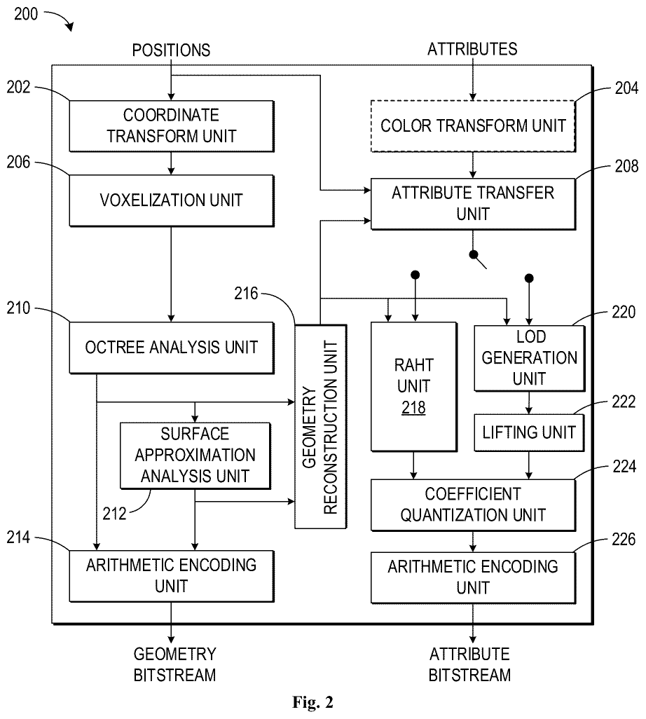

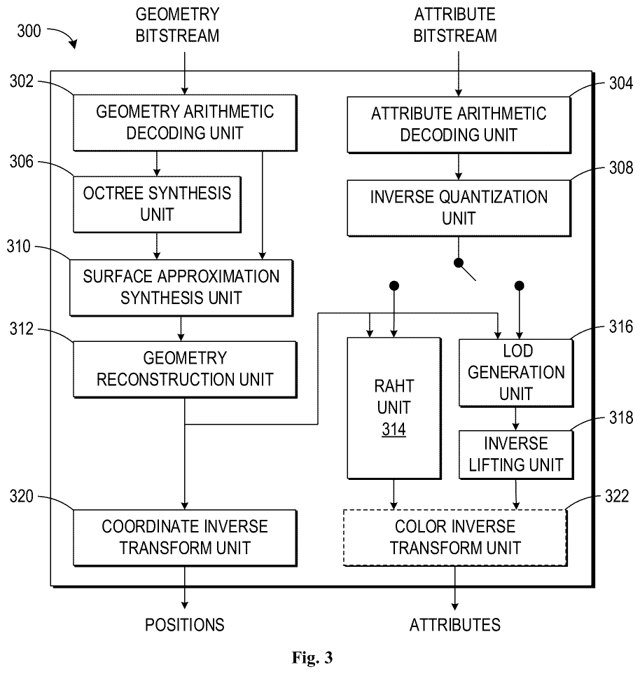

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is related to sample domain prediction for region-adaptive hierarchical transform (RAHT). The ideas may be applied individually or in various combination, to any point cloud coding standard or non-standard point cloud codec, e.g., the being-developed Geometry based Point Cloud Compression (G-PCC) and Low Latency Low Complexity Codec (L3C2).

### 2. Abbreviations

G-PCC Geometry based Point Cloud Compression
L3C2 Low Latency Low Complexity Codec
MPEG Moving Picture Experts Group
3DG 3D Graphics Coding Group
CFP Call For Proposal
V-PCC Video-based Point Cloud Compression
RAHT Region-Adaptive Hierarchical Transform
DC Direct Current
AC Alternating Current

### 3. Introduction

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Octree Geometry Compression

Point cloud codec can process the various information in different ways. Usually there are many optional tools in the codec to support the coding and decoding of geometry information and attribute information respectively. Among geometry coding tools in G-PCC, octree geometry compression has an important influence for point cloud geometry coding performance.

In G-PCC, one of important point cloud geometry coding tools is octree geometry compression, which leverages point cloud geometry spatial correlation. If geometry coding tools is enable, a cubical axis-aligned bounding box, associated with octree root node, will be determined according to point cloud geometry information. Then the bounding box will be subdivided into 8 sub-cubes, which are associated with 8 sub-nodes of root node (a cube is equivalent to node hereafter). An 8-bit code is then generated by specific order to indicate whether the 8 sub-nodes contain points separately, where one bit is associated with one sub-node. The bit associated with one sub-node is named occupancy bit and the 8-bit code generated is named occupancy code. The generated occupancy code will be signaled according to the occupancy information of neighbor node. Then only the nodes which contain points will be subdivided into 8 sub-nodes furtherly. The process will perform recursively until the node size is 1. So, the point cloud geometry information is converted into occupancy code sequences.

In decoder side, occupancy code sequences will be decoded and the point cloud geometry information can be reconstructed according to the occupancy code sequences.

A breadth-first scanning order will be used for the octree. In one level of the octree, the octree node will be scanned in a Morton order. If the coordinate of one node is represented by N bits, the coordinate (X, Y, Z) of the node can be represented as follows.

$$X = ( {x}_{N - 1} {x}_{N - 2} … {x}_{1} {x}_{0} )$$

$$Y = ( {y}_{N - 1} {y}_{N - 2} … {y}_{1} {y}_{0} )$$

$$Z = ( {z}_{N - 1} {z}_{N - 2} … {z}_{1} {z}_{0} )$$

Its Morton code can be represented as follows.

$$M = ( {x}_{N - 1} {y}_{N - 1} {z}_{N - 1} {x}_{N - 2} {y}_{N - 2} {z}_{N - 2} … {x}_{1} {y}_{1} {z}_{1} {x}_{0} {y}_{0} {z}_{0} )$$

The Morton order is the order from small to large or from large to small according to Morton code.

### 3.2 Region-Adaptive Hierarchical Transform

In G-PCC, one of important point cloud attribute coding tools is RAHT. It is a transform that uses the attributes associated with a node in a lower level of the octree to predict the attributes of the nodes in the next level. It assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level I be g_{l,x,y,z}, for x, y, z integers. g_{l,x,y,z} was obtained by grouping g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{l,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, say g_{l,2x,y,z} and g_{l,2x+1,y,z}, with their respective weights, ω1,2x,y,z and ω_{1,2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

$$where {ω}_{1} = {ω}_{l , 2 x , y , z} and {ω}_{2} = {ω}_{l , 2 x + 1 , y , z} and$$

$${T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted.

Furthermore, weights accumulate for the level above. In the above example,

ω_{l-1,2,y,z}=ω_{l,2x,y,z}+ω_{l,2x+1,y,z}

In the last stage, the tree root, the remaining two voxels g_{1,0,0,0} and g_{1,1,0,0} are transformed into the final two coefficients as:

$$[ \begin{matrix}{g}_{DC} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ] ,$$

$$where {g}_{D C} = {g}_{0 , 0 , 0 , 0} .$$

### 3.2.1 Upsampled Transform Domain Prediction

The transform domain prediction is introduced to improve coding efficiency on RAHT. It is formed of two parts. Firstly, the RAHT tree traversal is changed to be descent based from the previous ascent approach, i.e., a tree of attribute and weight sums is constructed and then RAHT is performed from the root level of the tree to the leaves level for both the encoder and the decoder. In each level, the node is visited in Morton order. The transform is performed in node that has 2×2×2 sub-nodes which is in the next level. The node in which transform is performed may be called as transform node.

Secondly, for each sub-node of transform node, a corresponding prediction attribute is produced by upsampling the attribute of previous transform level. Actually, only sub-node that contains at last one point will produce a corresponding prediction attribute. The transform node that contains prediction attributes is transformed and subtracted from the transformed attributes at the encoder side. The residual of alternating current (AC) coefficients will be signalled. Note that the prediction does not affect the direct current (DC) coefficient.

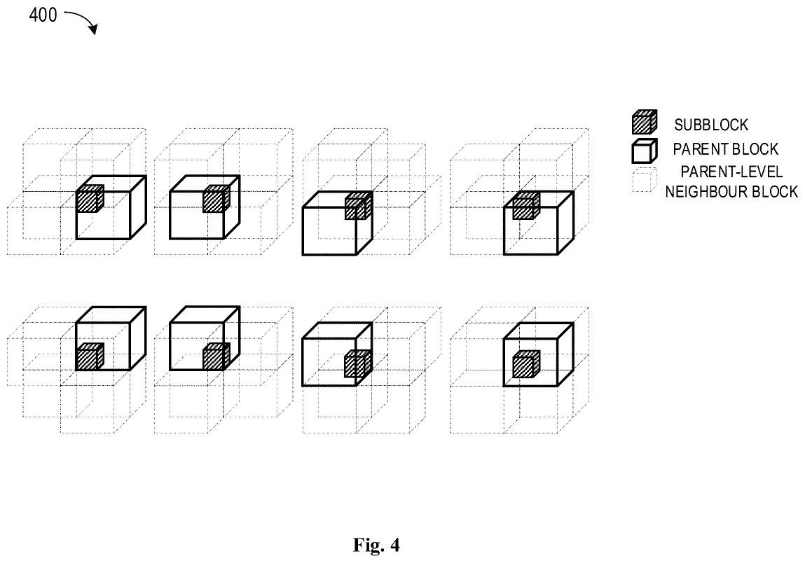

The each sub-node of transform node is predicted by 7 parent-level nodes where 3 coline parent-level neighbour nodes, 3 coplane parent-level neighbour nodes and 1 parent node. Coplane and coline neighbours are the neighbours that share a face and an edge with current transform node, respectively. A binary search algorithm is used to find coplane and coline parent-level neighbours. FIG. 4 illustrates parent-level nodes for each sub-node of transform unit node. FIG. 4 shows 7 parent-level nodes for each sub-node of transform node.

The attribute aᵤₚ of each sub-node is predicted depending on the distance between it and its parent-level node as

$${a}_{up} = \sum {ω}_{k} {a}_{k} / \sum {ω}_{k}$$

Where aₖ is the attribute of its one parent-level node and @ is weight depending on the distance. In G-PCC, ωₚₐᵣₑₙₜ:ω_{coplane}:ω_{coline}=4:2:1.

### 3.2.2 Early Termination for Transform Domain Prediction

Early termination is introduced to reduce complexity. In the upsampled transform domain prediction, 7 parent-level neighbour nodes are used to create the prediction value for each encoding target node (sub-node) of transform node. And there are total 19 parent-level neighbour nodes (containing parent node, i.e. transform unit node) which are used to create the prediction value for all 8 encoding target nodes of transform unit node. The prediction accuracy would be better in the denser point cloud because the number of valid neighbour parent nodes is larger. On the contrary, The prediction accuracy would be worse in the sparser point cloud. Based on this feature, the early termination for upsampled the transform domain prediction is introduced to reduce the coding time. In early termination, the following two parameters in every 8 sub-nodes of transform unit node are calculated.
NumValidP: total number of valid parent-level neighbour node (containing parent node).
NumValidGP: total number of valid grandparent-level neighbour node (containing grandparent node).

Then, the prediction will be disable in case that either NumValidP or NumValidGP is less than threshold. It means that the prediction is terminated when the number of valid neighbour nodes becomes small.

### 3.3 Problems

The existing designs for point cloud attribute transform domain prediction in region-adaptive hierarchical transform have the following problems:

The attribute prediction is performed in transform domain and it is suboptimal in complexity. In transform domain prediction, the transform is needed to be performed on the transform node and prediction transform node. If the attribute prediction can be performed in sample domain, the transform only needs to be performed on the prediction residual transform node. The complexity from transform can be reduced in sample domain prediction. Meanwhile, sample domain prediction and transform domain prediction are mathematically equivalent.

### 4. Detailed Solutions

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) The attribute of at least one neighbour may be used to predict the attribute of at least one sub-node of the transform node.
   a. In one example, one neighbour may be one node that shares at least a face, or an edge, or a vertex with the transform node.
      i. The neighbour and transform node may share the same octree depth.
      ii. The neighbour and transform node may have different octree depth.
   b. In one example, one neighbour may be one node that shares at least a face, or an edge, or a vertex with at least one subnode of the transform node.
      i. The neighbour and at least one subnode of the transform node may share the same octree depth.
      ii. The neighbour and at least one subnode of the transform node may have different octree depth.
   c. In one example, one neighbour may be one node that is close to the transform node or at least one subnode of the transform node in space distance.
      i. In one example, the distance may be the Euclidean distance, the Manhattan distance, the Chebyshev distance and so on.
      ii. The neighbour and at least one subnode of the transform node may share the same octree depth.
      iii. The neighbour and at least one subnode of the transform node may have different octree depth.
      iv. The neighbour and the transform node may share the same octree depth.
      v. The neighbour and the transform node may have different octree depth.
   d. In one example, for one neighbor, whether to and/or how to be used to in the prediction may be signaled from the encoder to the decoder.
   e. In one example, for one neighbor, whether to and/or how to be used to in the prediction may be derived by the decoder.
   f. In one example, which neighbors to be used in the prediction may be signaled from the encoder to the decoder.
   g. In one example, which neighbors to be used in the prediction may be derived by the decoder.
2) There may be a prediction weight for at least one neighbour.
   a. In one example, the prediction result from at least one neighbor may be the weighted average of the attributes of the neighbours.
   b. In one example, there may be a prediction weight for each neighbor.
   c. In one example, the prediction weight of one neighbour may be derived based on the positions and/or distance.
      i. In one example, the distance may be negatively correlated to the distance.
         1. In one example, the distance may be the Euclidean distance, the Manhattan distance, the Chebyshev distance and so on.
      ii. In one example, the distance may be distance between the neighbour and the transform node.
      iii. In one example, the distance may be distance between the neighbour and one subnode of the transform node.
3) There may be a predicted attribute for one subnode of transform node.
   a. In one example, one subnode may have a predicted attribute if it contains points.
      i. In one example, the predicted attribute may be the prediction result.
   b. The predicted attribute may be the fusion of the neighbour attributes.
      i. In one example, the fusion may be the weighted average of the neighbour attributes.
         1. In one example, the weighted average may be linear.
         2. In one example, the weighted average may be non-linear.
4) The prediction residual for one subnode of transform node may be derived.
   a. In one example, one subnode may have a prediction residual if it contains points.
   b. In one example, the prediction residual may be the difference between the predicted attribute and the attribute of one subnode of the transform node.
5) The prediction residual may be transformed to get transform coefficients at encoder and/or decoder.
   a. In one example, the transform maybe be region-adaptive hierarchical transform, wavelet transform, cosine transform and so on.
   b. In one example, the transform coefficients of the prediction residual may be signaled.
      i. In one example, only the AC coefficients may be signaled.
      ii. In one example, the DC coefficients may be inherited from the previous transform process.
      iii. In one example, the transform coefficients may be further processed multiple times before signaling.
         1. In one example, the processing may be quantization.
         2. In one example, the processing may be binarization with fixed-length coding, EG coding, (truncated) unary coding, etc.,
         3. The information of the quantization step may be signaled or derived.
      iv. In one example, the transform coefficients may be coded with at least one context in arithmetic coding.
      v. In one example, the transform coefficients may be bypass coded.
      vi. In one example, the transform coefficients may be coded by run-length.
6) The transform coefficients may be inversely transformed to get the prediction residual at encoder and/or decoder.
   a. The coefficients may be de-quantized before the inverse transform.
   b. In one example, the transform maybe be region-adaptive hierarchical transform, wavelet transform, cosine transform and so on.
   c. In one example, the AC coefficients may be reconstructed from the bitstream.
   d. In one example, the DC coefficients may be inferred.
      i. In one example, the DC coefficients of the transform of transform node may be inherited from the previous transform process.
      ii. In one example, the DC coefficients of the transform of the prediction residual may be the difference between the mean of the inherited value and the mean of the predicted attributes of the subnodes of the transform node.
   e. In one example, the AC and DC coefficients of the transform of the prediction residual may be inversely transformed to get the prediction residual.
7) Whether to apply the transform/inverse transform may be signaled from the encoder or derived at the decoder.
8) Which transform/inverse transform is used may be signaled from the encoder or derived at the decoder.

### 5. Embodiments

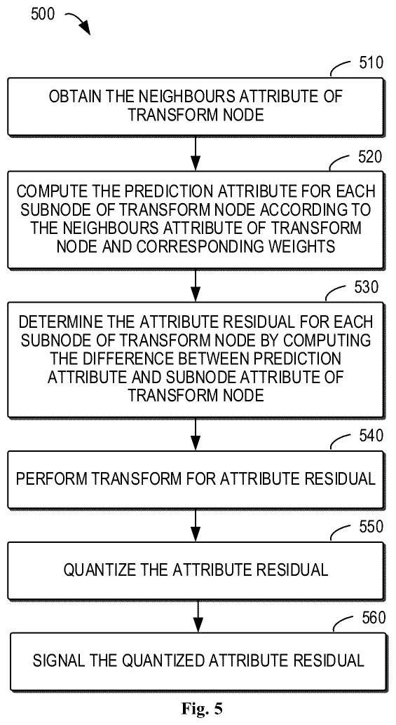

An example of the coding flow 500 for the sample domain prediction for region-adaptive hierarchical transform is depicted in FIG. 5. At 510, a neighbour attribute of the transform node is obtained. Then, at 520, a prediction attribute is computed for each subnode of transform node according to the neighbour attribute of the transform node and corresponding weights. At 530, an attribute residual is determined for each subnode of transform node by computing a difference between the prediction attribute and a subnode attribute of transform node. At 540, a transform is performed for the attribute residual determined at 530. At 550, the attribute residual, on which the transform has been performed, is quantized. At 560, the quantized attribute residual is signaled.

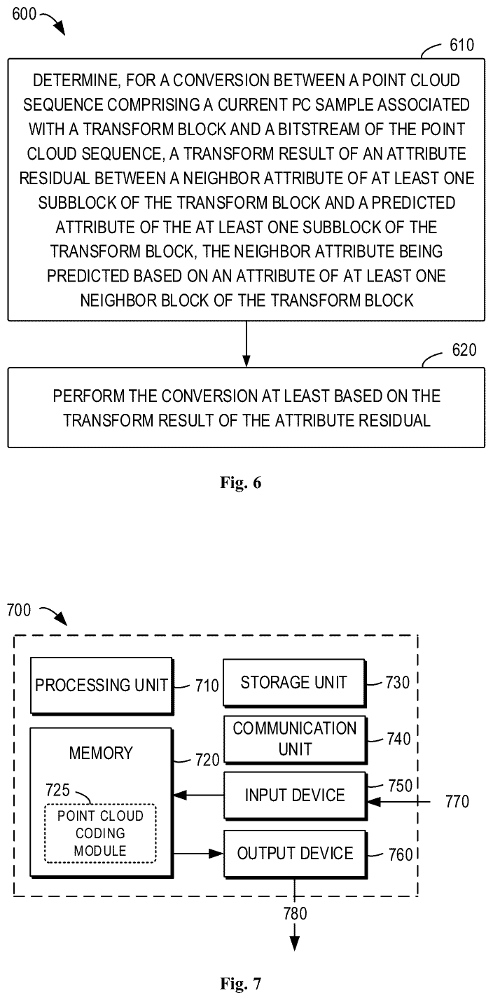

More details will be further discussed below. FIG. 6 illustrates a flowchart of a method 600 for point cloud coding in accordance with embodiments of the present disclosure.

At block 610, for a conversion between a point cloud sequence comprising a current point cloud (PC) sample associated with a transform block and a bitstream of the point cloud sequence, a transform result of an attribute residual between a neighbor attribute of at least one subblock of the transform block and a predicted attribute of the at least one subblock of the transform block is determined. The neighbor attribute is predicted based on an attribute of at least one neighbor block of the transform block.

At block 620, the conversion is performed at least based on the transform result of the attribute residual.

According to the method 600, the attribute prediction can be performed in sample domain, and thus the transform only needs to be performed on the prediction residual transform node. In this way, the complexity caused by transform can be reduced.

In some embodiments, the at least one neighbor block comprises a block that shares at least a face, or an edge, or a vertex with the transform block.

In some embodiments, the at least one neighbor block and the transform block share the same tree level or have different tree levels.

In some embodiments, a tree level comprises an octree depth.

In some embodiments, the at least one neighbor block comprises a block that shares at least a face, or an edge, or a vertex with the at least one subblock of the transform block.

In some embodiments, the at least one neighbor block and the at least one subblock share the same tree level or have different tree levels.

In some embodiments, a tree level comprises an octree depth.

In some embodiments, the at least one neighbour block comprises a block that is closest to the transform block or at least one subblock in terms of distance.

In some embodiments, the distance is one of a Euclidean distance, a Manhattan distance, or a Chebyshev distance.

In some embodiments, the at least one neighbor block and the at least one subblock share the same tree level or have different tree levels.

In some embodiments, the at least one neighbor block and the transform block share the same tree level or have different tree levels.

In some embodiments, a tree level comprises an octree depth.

In some embodiments, for one of the at least one neighbor block, whether to and/or how to be used to in the prediction is indicated from an encoder to a decoder, or is derived by the decoder. Alternatively, or in addition, in some embodiments, information of the at least one neighbor block to be used in the prediction is indicated from an encoder to a decoder, or is derived by the decoder.

In some embodiments, there is a prediction weight for each of the at least one neighbour block.

In some embodiments, a result of the neighbor attribute is a weighted average obtained based on an attributes of neighbor blocks and their respective prediction weights.

In some embodiments, a prediction weight of a neighbour block is derived based on a distance comprising at least one of: a distance between the neighbour block and the transform block, a distance between the neighbour block and a subblock of the transform block.

In some embodiments, the prediction weight is negatively correlated to the distance, or wherein the distance is one of a Euclidean distance, a Manhattan distance, or a Chebyshev distance.

In some embodiments, there is a predicted attribute for one subblock of the transform block.

In some embodiments, a subblock has a predicted attribute if it contains at least one point.

In some embodiments, the predicted attribute is the prediction result, or wherein the predicted attribute is a fusion of neighbour attributes.

In some embodiments, the fusion is a weighted average of the neighbour attributes.

In some embodiments, the weighted average may be linear or may be non-linear.

In some embodiments, the attribute residual is determined based on the neighbor attribute of the at least one subblock of the transform block and the predicted attribute of the at least one subblock of the transform block.

In some embodiments, one sub block has an attribute residual if it contains at least one point.

In some embodiments, the attribute residual is the difference between the neighbor attribute and the predicted attribute of one subblock of the transform block.

In some embodiments, the transform result is obtained by transforming the attribute residual at an encoder and/or a decoder.

In some embodiments, the transform is one of region-adaptive hierarchical transform, wavelet transform, or cosine transform.

In some embodiments, the transform result comprises transform coefficients, and the transform coefficients are indicated in the bitstream.

In some embodiments, the transform coefficients comprises Alternating Current (AC) coefficients and a Direct Current (DC) coefficient, and only the AC coefficients are indicated in the bitstream.

In some embodiments, the DC coefficients is inherited at the decoder from a previous transform process.

In some embodiments, the transform coefficients are further processed a plurality of times before indicated in the bitstream.

In some embodiments, the processing comprises at least one of: quantization, or binarization with fixed-length coding, EG coding, unary coding, or truncated unary coding.

In some embodiments, information on a step of the quantization is indicated in the bitstream or is derived at a decoder.

In some embodiments, the transform coefficients are coded with at least one context in arithmetic coding. Alternatively, the transform coefficients are bypass coded. As a further alternative, the transform coefficients are coded by run-length.

In some embodiments, the transform coefficients are inversely transformed to get the attribute residual at an encoder and/or a decoder.

In some embodiments, the coefficients are de-quantized before the inverse transform. Alternatively, the transform is one of region-adaptive hierarchical transform, wavelet transform, cosine transform. Alternatively, the AC coefficients are reconstructed from the bitstream. As a further alternative, the DC coefficients are inferred.

In some embodiments, the DC coefficients of the transform of the transform block are inherited from a previous transform process. Alternatively, the DC coefficients of the transform of the attribute residual are a difference between a mean of inherited values and a mean of the predicted attributes of subblocks of the transform block.

In some embodiments, the AC and DC coefficients of the transform of the attribute residual are inversely transformed to get the attribute residual.

In some embodiments, whether to apply the transform/inverse transform is indicated from an encoder to a decoder. Alternatively, whether to apply the transform/inverse transform is derived at the decoder.

In some embodiments, information on which transform/inverse transform is used is indicated from an encoder to a decoder. Alternatively, the information may be derived at the decoder.

In some embodiments, the current PC sample is one of the following: a frame, a picture, a slice, a sub-frame, a sub-picture, a tile, or a segment.

In some embodiments, the conversion includes encoding the current PC sample into the bitstream.

In some embodiments, the conversion includes decoding the current PC sample from the bitstream.

According to further embodiments of the present disclosure, a non-transitory computer-readable recording medium is provided. The non-transitory computer-readable recording medium stores a bitstream of a point cloud sequence which is generated by a method performed by an apparatus for point cloud coding.

According to the method, a transform result of an attribute residual between a neighbor attribute of at least one subblock of a transform block and a predicted attribute of the at least one subblock of the transform block is determined. The neighbor attribute is predicted based on an attribute of at least one neighbor block of the transform block. The bitstream is then generated at least based on the transform result of the attribute residual.

According to still further embodiments of the present disclosure, a method for storing bitstream of a point cloud sequence is provided. According to the method, a transform result of an attribute residual between a neighbor attribute of at least one subblock of a transform block and a predicted attribute of the at least one subblock of the transform block is determined. The neighbor attribute is predicted based on an attribute of at least one neighbor block of the transform block. The bitstream is then generated at least based on the transform result of the attribute residual. The generated bitstream is stored in a non-transitory computer-readable recording medium.

Implementations of the present disclosure can be described in view of the following clauses, the features of which can be combined in any reasonable manner.
Clause 1. A method for point cloud coding, comprising: determining, for a conversion between a point cloud sequence comprising a current point cloud (PC) sample associated with a transform block and a bitstream of the point cloud sequence, a transform result of an attribute residual between a neighbor attribute of at least one subblock of the transform block and a predicted attribute of the at least one subblock of the transform block, the neighbor attribute being predicted based on an attribute of at least one neighbor block of the transform block; and performing the conversion at least based on the transform result of the attribute residual.
Clause 2. The method of clause 1, wherein the at least one neighbor block comprises a block that shares at least a face, or an edge, or a vertex with the transform block.
Clause 3. The method of clause 1 or 2, wherein the at least one neighbor block and the transform block share the same tree level or have different tree levels.
Clause 4. The method of clause 3, wherein a tree level comprises an octree depth.
Clause 5. The method of clause 1, wherein the at least one neighbor block comprises a block that shares at least a face, or an edge, or a vertex with the at least one subblock of the transform block.
Clause 6. The method of clause 1 or 5, wherein the at least one neighbor block and the at least one subblock share the same tree level or have different tree levels.
Clause 7. The method of clause 6, wherein a tree level comprises an octree depth.
Clause 8. The method of clause 1, wherein the at least one neighbour block comprises a block that is closest to the transform block or at least one subblock in terms of distance.
Clause 9. The method of clause 8, wherein the distance is one of a Euclidean distance, a Manhattan distance, or a Chebyshev distance.
Clause 10. The method of clause 8, wherein the at least one neighbor block and the at least one subblock share the same tree level or have different tree levels.
Clause 11. The method of clause 8, wherein the at least one neighbor block and the transform block share the same tree level or have different tree levels.
Clause 12. The method of clause 10 or 11, wherein a tree level comprises an octree depth.
Clause 13. The method of clause 1, wherein for one of the at least one neighbor block, whether to and/or how to be used to in the prediction is indicated from an encoder to a decoder, or is derived by the decoder, or wherein information of the at least one neighbor block to be used in the prediction is indicated from an encoder to a decoder, or is derived by the decoder.
Clause 14. The method of clause 1, wherein there is a prediction weight for each of the at least one neighbour block.
Clause 15. The method of clause 14, wherein a result of the neighbor attribute is a weighted average obtained based on an attributes of neighbor blocks and their respective prediction weights.
Clause 16. The method of clause 14 or 15, wherein a prediction weight of a neighbour block is derived based on a distance comprising at least one of: a distance between the neighbour block and the transform block, a distance between the neighbour block and a subblock of the transform block.
Clause 17. The method of clause 16, wherein the prediction weight is negatively correlated to the distance, or wherein the distance is one of a Euclidean distance, a Manhattan distance, or a Chebyshev distance.
Clause 18. The method of clause 1, wherein there is a predicted attribute for one subblock of the transform block.
Clause 19. The method of clause 18, wherein a subblock has a predicted attribute if it contains at least one point.
Clause 20. The method of clause 18 or 19, wherein the predicted attribute is the prediction result, or wherein the predicted attribute is a fusion of neighbour attributes.
Clause 21. The method of clause 22, wherein the fusion is a weighted average of the neighbour attributes.
Clause 22. The method of clause 21, wherein the weighted average is linear or is non-linear.
Clause 23. The method of clause 21, wherein the attribute residual is determined based on the neighbor attribute of the at least one subblock of the transform block and the predicted attribute of the at least one subblock of the transform block.
Clause 24. The method of clause 23, wherein one sub block has an attribute residual if it contains at least one point.
Clause 25. The method of clause 23 or 24, wherein the attribute residual is the difference between the neighbor attribute and the predicted attribute of one subblock of the transform block.
Clause 26. The method of any of clauses 1 to 25, wherein the transform result is obtained by transforming the attribute residual at an encoder and/or a decoder.
Clause 27. The method of any of clauses 1 to 26, wherein the transform is one of region-adaptive hierarchical transform, wavelet transform, or cosine transform.
Clause 28. The method of any of clauses 1 to 27, wherein the transform result comprises transform coefficients, and the transform coefficients are indicated in the bitstream.
Clause 29. The method of clause 28, wherein the transform coefficients comprises Alternating Current (AC) coefficients and a Direct Current (DC) coefficient, and wherein only the AC coefficients are indicated in the bitstream.
Clause 30. The method of clause 29, wherein the DC coefficients is inherited at the decoder from a previous transform process.
Clause 31. The method of any of clause 28-30, wherein the transform coefficients are further processed a plurality of times before indicated in the bitstream.
Clause 32. The method of clause 31, wherein the processing comprises at least one of: quantization, or binarization with fixed-length coding, EG coding, unary coding, or truncated unary coding.
Clause 33. The method of clause 32, wherein information on a step of the quantization is indicated in the bitstream or is derived at a decoder.
Clause 34. The method of clause 28, wherein the transform coefficients are coded with at least one context in arithmetic coding, or wherein the transform coefficients are bypass coded, or wherein the transform coefficients are coded by run-length.
Clause 35. The method of clause 28, wherein the transform coefficients are inversely transformed to get the attribute residual at an encoder and/or a decoder.
Clause 36. The method of clause 35, wherein the coefficients are de-quantized before the inverse transform, or wherein the transform is one of region-adaptive hierarchical transform, wavelet transform, cosine transform, or wherein the AC coefficients are reconstructed from the bitstream, or wherein the DC coefficients are inferred.
Clause 37. The method of clause 36, wherein the DC coefficients of the transform of the transform block are inherited from a previous transform process, or wherein the DC coefficients of the transform of the attribute residual are a difference between a mean of inherited values and a mean of the predicted attributes of subblocks of the transform block.
Clause 38. The method of clause 35, wherein the AC and DC coefficients of the transform of the attribute residual are inversely transformed to get the attribute residual.
Clause 39. The method of any of clauses 1 to 38, wherein whether to apply the transform/inverse transform is indicated from an encoder or is derived at a decoder.
Clause 40. The method of any of clauses 1 to 39, wherein information on which transform/inverse transform is used is indicated from an encoder or is derived at a decoder.
Clause 41. The method of any of clauses 1-40, wherein the current PC sample is one of the following:

a frame, a picture, a slice, a sub-frame, a sub-picture, a tile, or a segment.
Clause 42. The method of any of clauses 1-41, wherein the conversion includes encoding the current PC sample into the bitstream.
Clause 43. The method of any of clauses 1-41, wherein the conversion includes decoding the current PC sample from the bitstream.
Clause 44. An apparatus for point cloud coding comprising a processor and a non-transitory memory with instructions thereon, wherein the instructions upon execution by the processor, cause the processor to perform a method in accordance with any of clauses 1-43.
Clause 45. A non-transitory computer-readable storage medium storing instructions that cause a processor to perform a method in accordance with any of clauses 1-43.
Clause 46. A non-transitory computer-readable recording medium storing a bitstream of a point cloud sequence which is generated by a method performed by a point cloud processing apparatus, wherein the method comprises: determining a transform result of an attribute residual between a neighbor attribute of at least one subblock of a transform block and a predicted attribute of the at least one subblock of the transform block, the neighbor attribute being predicted based on an attribute of at least one neighbor block of the transform block; and generating the bitstream at least based on the transform result of the attribute residual.
Clause 47. A method for storing a bitstream of a point cloud sequence, comprising: determining a transform result of an attribute residual between a neighbor attribute of at least one subblock of a transform block and a predicted attribute of the at least one subblock of the transform block, the neighbor attribute being predicted based on an attribute of at least one neighbor block of the transform block; generating the bitstream at least based on the transform result of the attribute residual; and storing the bitstream in a non-transitory computer-readable recording medium.

### Example Device

FIG. 7 illustrates a block diagram of a computing device 700 in which various embodiments of the present disclosure can be implemented. The computing device 700 may be implemented as or included in the source device 110 (or the GPCC encoder 116 or 200) or the destination device 120 (or the GPCC decoder 126 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement point cloud encoding/decoding in embodiments of the present disclosure. The memory 720 may include one or more point cloud coding modules 725 having one or more program instructions. These modules are accessible and executable by the processing unit 710 to perform the functionalities of the various embodiments described herein.

In the example embodiments of performing point cloud encoding, the input device 750 may receive point cloud data as an input 770 to be encoded. The point cloud data may be processed, for example, by the point cloud coding module 725, to generate an encoded bitstream. The encoded bitstream may be provided via the output device 760 as an output 780.

In the example embodiments of performing point cloud decoding, the input device 750 may receive an encoded bitstream as the input 770. The encoded bitstream may be processed, for example, by the point cloud coding module 725, to generate decoded point cloud data. The decoded point cloud data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for point cloud coding, comprising:
determining, for a conversion between a point cloud sequence comprising a current point cloud (PC) sample associated with a transform block and a bitstream of the point cloud sequence, a transform result of an attribute residual between a neighbor attribute of at least one subblock of the transform block and a predicted attribute of the at least one subblock of the transform block, the neighbor attribute being predicted based on an attribute of at least one neighbor block of the transform block; and
performing the conversion at least based on the transform result of the attribute residual.

2. The method of claim 1, wherein the at least one neighbor block comprises a block that shares at least a face, or an edge, or a vertex with the transform block, or
wherein the at least one neighbor block comprises a block that shares at least a face, or an edge, or a vertex with the at least one subblock of the transform block.

3. The method of claim 1, wherein the at least one neighbor block and the transform block share the same tree level or have different tree levels, wherein a tree level comprises an octree depth, or
wherein the at least one neighbor block and the at least one subblock share the same tree level or have different tree levels, wherein a tree level comprises an octree depth.

4. The method of claim 1, wherein the at least one neighbour block comprises a block that is closest to the transform block or at least one subblock in terms of distance,
wherein the distance is one of a Euclidean distance, a Manhattan distance, or a Chebyshev distance,
wherein the at least one neighbor block and the at least one subblock share the same tree level or have different tree levels, wherein a tree level comprises an octree depth, or
wherein the at least one neighbor block and the transform block share the same tree level or have different tree levels, wherein a tree level comprises an octree depth.

5. The method of claim 1, wherein for one of the at least one neighbor block, whether to and/or how to be used to in the prediction is indicated from an encoder to a decoder, or is derived by the decoder, or
wherein information of the at least one neighbor block to be used in the prediction is indicated from an encoder to a decoder, or is derived by the decoder.

6. The method of claim 1, wherein there is a prediction weight for each of the at least one neighbour block,
wherein a result of the neighbor attribute is a weighted average obtained based on an attributes of neighbor blocks and their respective prediction weights, and/or
wherein a prediction weight of a neighbour block is derived based on a distance comprising at least one of: a distance between the neighbour block and the transform block, or a distance between the neighbour block and a subblock of the transform block.

7. The method of claim 6, wherein the prediction weight is negatively correlated to the distance, and/or
wherein the distance is one of a Euclidean distance, a Manhattan distance, or a Chebyshev distance.

8. The method of claim 1, wherein there is a predicted attribute for one subblock of the transform block,
wherein a subblock has a predicted attribute if it contains at least one point,
wherein the predicted attribute is the prediction result, or
wherein the predicted attribute is a fusion of neighbour attributes, wherein the fusion is a weighted average of the neighbour attributes, wherein the weighted average is linear or non-linear.

9. The method of claim 8, wherein the attribute residual is determined based on the neighbor attribute of the at least one subblock of the transform block and the predicted attribute of the at least one subblock of the transform block,
wherein one sub block has an attribute residual if it contains at least one point, and/or
wherein the attribute residual is the difference between the neighbor attribute and the predicted attribute of one subblock of the transform block.

10. The method of claim 1, wherein the transform result is obtained by transforming the attribute residual at an encoder and/or a decoder, and/or
wherein the transform is one of region-adaptive hierarchical transform, wavelet transform, or cosine transform.

11. The method of claim 1, wherein the transform result comprises transform coefficients, and the transform coefficients are indicated in the bitstream.

12. The method of claim 11, wherein the transform coefficients comprise Alternating Current (AC) coefficients and a Direct Current (DC) coefficient, and wherein only the AC coefficients are indicated in the bitstream, and/or
wherein the DC coefficients are inherited at a decoder from a previous transform process, and/or
wherein the transform coefficients are further processed a plurality of times before indicated in the bitstream, wherein the processing comprises at least one of: quantization, or binarization with fixed-length coding, EG coding, unary coding, or truncated unary coding, wherein information on a step of the quantization is indicated in the bitstream or is derived at a decoder.

13. The method of claim 11, wherein the transform coefficients are coded with at least one context in arithmetic coding, or
wherein the transform coefficients are bypass coded, or
wherein the transform coefficients are coded by run-length.

14. The method of claim 11, wherein the transform coefficients are inversely transformed to get the attribute residual at an encoder and/or a decoder,
wherein the coefficients are de-quantized before the inverse transform, or
wherein the transform is one of region-adaptive hierarchical transform, wavelet transform, cosine transform, or
wherein the AC coefficients are reconstructed from the bitstream, or
wherein the DC coefficients are inferred, and/or
wherein the AC and DC coefficients of the transform of the attribute residual are inversely transformed to get the attribute residual.

15. The method of claim 14, wherein the DC coefficients of the transform of the transform block are inherited from a previous transform process, or
wherein the DC coefficients of the transform of the attribute residual are a difference between a mean of inherited values and a mean of the predicted attributes of subblocks of the transform block, and/or
wherein the current PC sample is one of the following: a frame, a picture, a slice, a sub-frame, a sub-picture, a tile, or a segment.

16. The method of claim 1, wherein the conversion includes encoding the current PC sample into the bitstream, or
wherein the conversion includes decoding the current PC sample from the bitstream.

17. An apparatus for point cloud coding comprising a processor and a non-transitory memory with instructions thereon, wherein the instructions upon execution by the processor, cause the processor to perform a method comprising:
determining, for a conversion between a point cloud sequence comprising a current point cloud (PC) sample associated with a transform block and a bitstream of the point cloud sequence, a transform result of an attribute residual between a neighbor attribute of at least one subblock of the transform block and a predicted attribute of the at least one subblock of the transform block, the neighbor attribute being predicted based on an attribute of at least one neighbor block of the transform block; and
performing the conversion at least based on the transform result of the attribute residual.

18. The apparatus of claim 17, wherein the at least one neighbor block comprises a block that shares at least a face, or an edge, or a vertex with the transform block, or
wherein the at least one neighbor block comprises a block that shares at least a face, or an edge, or a vertex with the at least one subblock of the transform block, or
wherein the at least one neighbor block and the transform block share the same tree level or have different tree levels, wherein a tree level comprises an octree depth, or
wherein the at least one neighbor block and the at least one subblock share the same tree level or have different tree levels, wherein a tree level comprises an octree depth.

19. A non-transitory computer-readable storage medium storing instructions that cause a processor to perform a method comprising:
determining, for a conversion between a point cloud sequence comprising a current point cloud (PC) sample associated with a transform block and a bitstream of the point cloud sequence, a transform result of an attribute residual between a neighbor attribute of at least one subblock of the transform block and a predicted attribute of the at least one subblock of the transform block, the neighbor attribute being predicted based on an attribute of at least one neighbor block of the transform block; and
performing the conversion at least based on the transform result of the attribute residual.

20. A non-transitory computer-readable recording medium storing a bitstream of a point cloud sequence which is generated by a method performed by a point cloud processing apparatus, wherein the method comprises:
determining a transform result of an attribute residual between a neighbor attribute of at least one subblock of a transform block in the point cloud sequence and a predicted attribute of the at least one subblock of the transform block, the neighbor attribute being predicted based on an attribute of at least one neighbor block of the transform block; and
generating the bitstream at least based on the transform result of the attribute residual.
